(19) United States
(12) Patent Application Publication
(10) Pub. No.: US 2021/0027219 A1
(43) Pub. Date: Jan. 28, 2021

(54) CHANGE MANAGEMENT PLATFORM FOR SCOPING CHANGE MANAGEMENT IN ENTERPRISES

(71) Applicant: Accenture Global Solutions Limited, Dublin (IE)

(72) Inventors: Kara Arline Braniff Hobson, La Mesa, CA (US); Sarah Gottry Bartel, Carnation, WA (US); Leena Maarit Poikolainen, London (GB)

(21) Appl. No.: 16/677,860

(22) Filed: Nov. 8, 2019

Related U.S. Application Data
(60) Provisional application No. 62/878,434, filed on Jul. 25, 2019.

(51) Int. Cl. G06Q 10/06; G06Q 30/02; G06F 3/0482

(52) U.S. Cl. CPC G06Q 10/0637; G06F 3/0482; G06Q 30/0203

(57) ABSTRACT

Methods, systems, and computer-readable storage media for receiving first user input from a user, the first input indicating selection of a first change management tool from a set of change management tools provided by the change management platform, providing a first survey for display to the user, the first survey including one or more questions, the first survey being specific to the first change management tool selected by the user, receiving a first set of user answers including user input indicating user selection of a set of answers to the first survey, calculating an overall value and a set of dimension values based on answer values assigned to answers in the set of answers selected by the user, and providing one or more reports for display to the user, each of the one or more reports including graphical representations based on the overall value and the set of dimension values.

### CROSS-REFERENCE TO RELATED APPLICATIONS

This application claims priority to and the benefit of U.S. Prov. App. Ser. No. 62/878,434, filed on Jul. 25, 2019, the disclosure of which is expressly incorporated herein by reference in the entirety for all purposes.

### BACKGROUND

In enterprise operations, changes can occur that can impact a significant number of levels of the enterprise and/or entities external to the enterprise (e.g., customers). Changes in enterprises can be prompted by various situations including, for example, technological progress, process reviews, customer changes, competition, acquisitions, mergers, and organizational restructuring. An example change can include, without limitation, introduction of an information technology (IT) system into the operations of an enterprise (e.g., to enhance competitiveness of the enterprise; in response to customer requirements). Change management can be generally described as the process to prepare, support, and assist individuals and teams within an enterprise in implementing change. Change management can include phases of identification of the change, evaluation of impact and effort required to implement the change (e.g., time, cost, resources), and executing implementation of the change.

In evaluating impact and effort required to implement changes, evaluation tools have been developed. Traditional evaluation tools, however, are overly complex and can require an unsatisfactory amount of time to provide evaluation of a change. For example, traditional evaluation tools require a relatively high number of inputs, which increases time required to determine and confirm values of each input, and increased technical resources expended (e.g., processors, memory) in executing calculations based on the inputs.

### SUMMARY

Implementations of the present disclosure are generally directed to computer-implemented systems for a change management platform. More particularly, implementations of the present disclosure are directed to a computer-implemented change management platform that provides instant directional data with high-level conclusions to scope change management of a change that is to be implemented within an enterprise.

In some implementations, actions include receiving first user input from a user, the first input indicating selection of a first change management tool from a set of change management tools provided by the change management platform, providing a first survey for display to the user, the first survey including one or more questions, the first survey being specific to the first change management tool selected by the user, receiving a first set of user answers including user input indicating user selection of a set of answers to the first survey, calculating an overall value and a set of dimension values based on answer values assigned to answers in the set of answers selected by the user, and providing one or more reports for display to the user, each of the one or more reports including graphical representations based on the overall value and the set of dimension values. Other implementations of this aspect include corresponding systems, apparatus, and computer programs, configured to perform the actions of the methods, encoded on computer storage devices.

These and other implementations can each optionally include one or more of the following features: actions further include determining a set of actions based on one or more of the overall value and one or more answers in the set of answers; determining a set of actions is executed using a mapping that associates one or more overall values to at least one action and that associates at least one answer of the one or more answers to at least one action; at least two actions are included in the set of actions based on the overall value; a respective action is included in the set of actions based on each of the one or more answers; a type of each of the overall value and the dimension values is specific to the first change management tool selected by the user; actions further include receiving second user input from the user, the second input indicating selection of a second change management tool from the set of change management tools, providing a second survey for display to the user, the second survey being specific to the second change management tool selected by the user, receiving a second set of user answers comprising user input indicating user selection of a set of answers to the second survey, calculating an overall value and a set of dimension values based on answer values assigned to answers in the set of answers selected by the user, and providing one or more reports for display to the user, each of the one or more reports including graphical representations based on the overall value and the set of dimension values; actions further include retrieving the first survey from a plurality of pre-defined surveys based on the first change management tool selected by the user; and actions further include receiving configuration data from an administrator, and updating one or more surveys of the plurality of pre-defined surveys based on the configuration data.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 depicts an example system that can execute implementations of the present disclosure.

FIG. 2 depicts an example process flow in accordance with implementations of the present disclosure.

FIG. 3 depicts an example conceptual architecture in accordance with implementations of the present disclosure.

FIG. 4 depicts an example workflow sequence diagram in accordance with implementations of the present disclosure.

FIGS. 5A-5H and 6 depict example user interfaces of an example change management tool in accordance with implementations of the present disclosure.

FIG. 7 depicts an example process that can be executed in accordance with implementations of the present disclosure.

Like reference symbols in the various drawings indicate like elements.

### DETAILED DESCRIPTION

Implementations of the present disclosure are generally directed to computer-implemented systems for a change management platform. More particularly, implementations of the present disclosure are directed to a computer-implemented change management platform that provides instant directional data with high-level conclusions to scope change management of a change that is to be implemented within an enterprise. In some implementations, actions include receiving first user input from a user, the first input indicating selection of a first change management tool from a set of change management tools provided by the change management platform, providing a first survey for display to the user, the first survey including one or more questions, the first survey being specific to the first change management tool selected by the user, receiving a first set of user answers including user input indicating user selection of a set of answers to the first survey, calculating an overall value and a set of dimension values based on answer values assigned to answers in the set of answers selected by the user, and providing one or more reports for display to the user, each of the one or more reports including graphical representations based on the overall value and the set of dimension values.

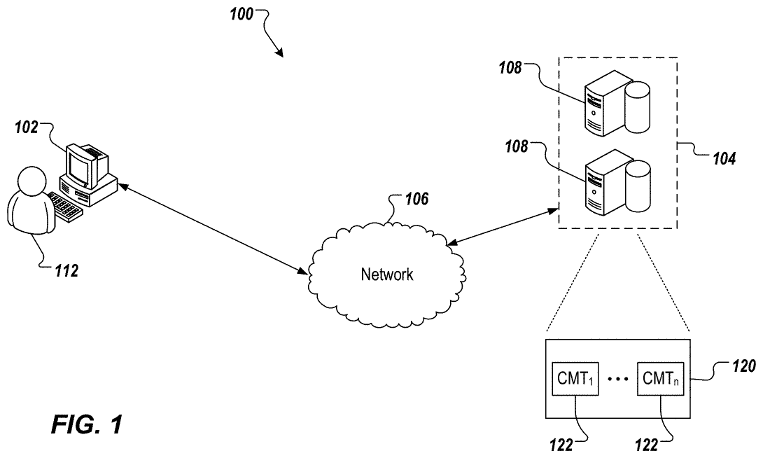

FIG. 1 depicts an example system 100 that can execute implementations of the present disclosure. The example system 100 includes a computing device 102, a back-end system 104, and a network 106. In some examples, the network 106 includes a local area network (LAN), wide area network (WAN), the Internet, or a combination thereof, and connects web sites, devices (e.g., the computing device 102), and back-end systems (e.g., the back-end system 104). In some examples, the network 106 can be accessed over a wired and/or a wireless communications link. For example, mobile computing devices, such as smartphones can utilize a cellular network to access the network 106.

In some examples, the computing device 102 can include any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices.

In the depicted example, the back-end system 104 includes at least one server system 108 and data store (e.g., database). In some examples, the at least one server system 108 hosts one or more computer-implemented services that users can interact with using computing devices. For example, the server system 108 can host a change management platform 120 that provides instant directional data with high-level conclusions to scope change management of a change that is to be implemented within an enterprise in accordance with implementations of the present disclosure. More particularly, and as described in further detail herein, the change management platform 120 can include a set of change management tools (CMTs) 122, each of which enables users to scope change management solutions in a time- and resource-efficient manner.

In accordance with implementations of the present disclosure, the change management platform provides instant directional data with high-level conclusions to scope change management of a change that is to be implemented within an enterprise. In some implementations, original process methodology is powered by a digital survey. In some examples, the digital survey is specific to the particular change management tool being used. For example, and as described in further detail herein, the change management platform can provide a first change management tool that includes a robust survey (e.g., referred to herein as CMT-Full) and a second change management tool that includes a lean survey (e.g., referred to herein as CMT-Agile). In some implementations, data choices are selected by a user (e.g., a user 112 interacting with the computing device 102 in FIG. 1), and an application programming interface (API) runs unique algorithms and calculates the response selections. In some implementations, data is displayed in original visual reports based on the calculations and algorithms. In some implementations, a set of change activities and a set of process activities are provided.

In general, the change management platform of the present disclosure enables users to scope change management of a change that is to be implemented within an enterprise in a standard, quick and engaging way, while providing time and resource efficiencies. In some implementations, the change management platform provides a mobilization phase tool to help enterprises accelerate the high-level change impacts and estimating processes. In some implementations, the change management platform of the present disclosure: standardizes the technology process behind human activities by using a digital framework and algorithms that automate decisions and actions; advances the technology behind critical processes; expedites technology delivery by providing instant data (e.g., instead of weeks, relevant data can be provided in minutes, if not more quickly); and dynamically calculates risk scores based on unique combinations of responses that show impacts on human and organizational behaviors.

Implementations of the present disclosure provide algorithms that calculate change impact risk summary for a single complete survey, algorithms that calculate change impact risk summaries for multiple complete surveys, algorithms that calculate change impact risk by dimension, algorithms that calculate impact risk for heatmap reports, multiple dimensions (e.g., 5 dimensions) with elements and a multi-question (e.g., 9-questions for Agile; 22-questions for Full) framework feeding the calculations, automated digital reporting generation, and enables users to instantly generate a multitude of reports across a multitude of factors for total customization.

In further detail, the change management platform of the present disclosure provides directional data to scope change management of a change that is to be implemented within an enterprise across multiple dimensions. In some implementations, dimensions evaluated can be specific to the particular change management tool selected from the change management platform. For example, a first change management tool (e.g., CMT-Full) can be used for a technical solution that is to be implemented within an enterprise (e.g., a new IT system, an update to an existing IT system, a new billing system, etc.). For the first change management tool, example dimensions can include, without limitation, scope, complexity, degree of change, support, and change readiness. As another example, a second change management tool (e.g., CMT-Agile) can be used for a change related to one or more of a feature and an epic within an enterprise. In some examples, a feature represents a concrete output (e.g., a shippable component of software) provided by the enterprise. In some examples, an epic represents an initiative that is to be accomplished by the enterprise (e.g., increase customer engagement, improve user experience). For the second change management tool, example dimensions can include, without limitation, customers, people, tools, and process.

In some implementations, the change management tool provides a digital survey that includes a set of questions and, for each question, a set of answers. For example, and with reference to the first change management tool introduced above, an example set of questions and respective sets of answers are provided in Table 1:

TABLE 1
Example Survey Questions for CMT - Full

| | Question | Answers | | |
|---|---|---|---|---|
| 1 | Number of geographies | One geography | Two geographies | Geographies impacted |
| | impacted? | or a few | or several | do business in |
| | | countries that | countries doing | different ways or the |
| | | all do | business in | impact is worldwide. |
| | | business in | similar ways. | |
| | | similar ways. | | |
| 2 | How many different | A few | Several | Many |
| | organizations are impacted | organizations. | organizations. | organizations. |
| | (e.g., lines of business, | | | |
| | divisions, subsidiaries)? | | | |
| 3 | What type of stakeholder | Internal | Internal and | Customers are directly |
| | groups are impacted? | stakeholders | some external. | impacted. |
| | | only. | | |
| 4 | How many different types | <10% | 11-30% | >30% |
| | of roles in the organization | | | |
| | are impacted as a percent | | | |
| | of the total? | | | |
| 5 | How many stakeholders or | <10% | 11-30% | >30% |
| | users in the organization | | | |
| | are impacted as a percent | | | |
| | of the total? | | | |
| 6 | Are policies, security or | Not many. | Some. | Many. |
| | regulations changing? | | | |
| 7 | Will this initiative create | No. | To a small | Yes, probably a lot. |
| | conflicting priorities? | | degree. | |
| 8 | How many different | None or a | Several. | A lot. |
| | systems or tools are | few. | | |
| | changing? | | | |
| 9 | Are processes changing? | None or a | Several. | A lot. |
| | | few. | | |
| 10 | How much will this | Not much. | Some. | A lot. |
| | initiative impact the | | | |
| | organization's structure | | | |
| | (headcount, org alignment, | | | |
| | etc.)? | | | |
| 11 | How different will “doing | Not that | Some | Very different. |
| | business” or “getting the | different. | differences. | |
| | job done” be in the future | | | |
| | because of this initiative? | | | |
| 12 | Will the stakeholders | No, or very | Some new skills, | Many or complex new |
| | impacted require new skills | few new | but many of are | skills will be required. |
| | to “do business” or “get the | skills. | simple. | |
| | job done” in the future | | | |
| | because of this initiative? | | | |
| 13 | Is the change consistent | Mostly | The change will | The change will |
| | with the existing culture | consistent. | challenge the | considerably |
| | and expectations? | | existing culture | challenge the existing |
| | | | and expectations | culture and people |
| | | | to some extent. | will have to reset their |
| | | | | expectations. |
| 14 | How do you think this | Positive. | Neutral. | Mostly negative. |
| | initiative will be | | | |
| | perceived? | | | |
| 15 | Change resilient: are | To a large | To some degree. | Not used to change or |
| | people accustomed and | degree. | | resistant. |
| | adaptable to change? | | | |
| 16 | Has an influential leader | Someone has been | This may not be | No one has been |
| | has been identified to | identified, and | complete, but it | identified, or the case |
| | sponsor the change and can | there is | is a priority. | for change may be |
| | clearly communicate a case | confidence | | communicated with |
| | for change? | that the case | | mixed messages. |
| | | for change | | |
| | | will be | | |
| | | compelling. | | |
| 17 | Middle management is | Yes, | Yes, the majority | Unsure, or not |
| | equipped with skills to | consistently. | and most of the | completely confident |
| | manage people and | | time. | in one or more of |
| | initiatives, such as this one, | | | these areas. |
| | and has decision authority | | | |
| | to consistently execute | | | |
| | required tasks? | | | |
| 18 | Is success clearly defined | Yes. | Somewhat. | Not really. |
| | for this initiative> | | | |
| 19 | Are teams accustomed to | Yes. | Somewhat. | Not really. |
| | measuring and upholding | | | |
| | goals and targets | | | |
| | consistently? | | | |
| 20 | Were the results of | Yes. | Somewhat. | Not really. |
| | previous or similar | | | |
| | initiatives successful? | | | |
| 21 | Does this initiative have | Yes. | Somewhat. | Not really. |
| | resources and support to | | | |
| | ensure the right people are | | | |
| | in place to make the | | | |
| | change a success? | | | |
| 22 | Change capable: does the | Yes, and most | A few methods | No methodology. |
| | organization have a | people are | are used most of | |
| | methodology for change | familiar with | the time. | |
| | management? | it. | | |

As another example, and with reference to the second change management tool introduced above, an example set of questions and respective sets of answers are provided in Table 2:

TABLE 2
Example Survey Questions for CMT - Agile

| | Questions | Answers | | |
|---|---|---|---|---|
| 1 | Are external customers | No impact on | Some impact on | Significant impact on |
| | impacted by the change? | external customer. | external customers. | external customers. |
| 2 | Does the feature/epic | No changes in | New roles and | New roles and |
| | require changes in roles & | roles & | responsibilities | responsibilities |
| | responsibilities? | responsibilities. | are required and | are required and |
| | | | defined. | not yet defined. |
| 3 | Does the feature/epic | No | Minor | Significant |
| | impact the organization | organizational | organizational | organizational |
| | structure? (headcount, org. | structure impact. | structure impact. | structure impact. |
| | alignment etc.)? | | | |
| 4 | Does feature/epic have an | No cultural | The change will | The change is |
| | impact on the company | change. | challenge the | going to |
| | culture/behaviors? | | existing culture and | considerably |
| | | | expectations to some | challenge the |
| | | | extent. | exiting culture and |
| | | | | people will have |
| | | | | to reset their |
| | | | | expectations. |
| 5 | How many internal | Only one business | Few business units | Several business |
| | stakeholders/divisions are | unit and less than | are impacted and/or | units are |
| | impacted by the | 20% of | between 20-50% of | impacted and/or |
| | feature/epic? | stakeholders or | stakeholders or users | more than 50% |
| | | users are | are impacted. | of stakeholders |
| | | impacted. | | or users are |
| | | | | impacted. |
| 6 | How much are the | Less than 20% of | 20-50% of | More than 50% of |
| | individual's ways of | an individual's | an individual's | an individual's |
| | working and skillsets | ways of working | ways of working | ways of working |
| | changing | and skill sets are | and skill sets are | and skill sets are |
| | | changing. | changing. | changing. |
| 7 | Are the impacted groups | Accustomed to | Somewhat | Not used to |
| | accustomed and adaptable | change and/or not | accustomed and/or | change and/or |
| | to change? | resistant. | some degree of | resistant. |
| | | | resistance. | |
| 8 | What are the changes in | Proposed change | Proposed change | Proposed change |
| | tools/systems/data related | is related to a | is affecting a | is affecting a |
| | to the feature/epic? | single system | fundamental | business-critical |
| | | functionality and | system/data/interface | system/data/ |
| | | any deviations can | used by few teams. | interface used |
| | | be easily | | by a significant |
| | | managed. | | number of teams. |
| 9 | Does the feature/epic | Small change to | Large change to | Significant |
| | require changes to the | existing process. | existing business | and/or end to |
| | existing processes? | | process. | end change of |
| | | | | the existing |
| | | | | business process. |

In some examples, sub-sets of questions are provided, each sub-set corresponding to a respective dimension. For example, and with reference to Table 1, above, questions 1-5 can correspond to scope, questions 6-9 can correspond to complexity, questions 10-13 can correspond to degree of change, questions 14-17 can correspond to support, and questions 18-22 can correspond to change readiness. As another example, and with reference to Table 2, above, question 1 can correspond to customers, questions 2-7 can correspond to people, question 8 can correspond to tools, and question 9 can correspond to process.

In some implementations, a set of values are determined and can include an overall value of the change or feature/epics, and a dimension value for each dimension. In some examples, values in the set of values are determined based on answer values assigned to respective answers. More particularly, and as introduced above, each question has a set of answers associated therewith, and each answer can be associated with an answer value. Example answer values can include, without limitation, numerical values (e.g., 1, 2, 3; 0.5, 0.7, 1.2) and text values (e.g., L (low), M (medium), H (high); M (medium), L (large), XL (extra-large)). In some examples, a value represents a degree of impact, difficulty, and/or size (e.g., 1 or L representing a low degree of impact and/or difficulty, and 3 or H representing a low degree of impact and/or difficulty; 0.5 or M representing a medium size, and 1.2 or XL representing an extra-large size)). In some examples, a text value can correspond to a numerical value. For example, a text value of L can correspond to a numerical value of 1, a text value of M can correspond to a numerical value of 2, and a text value of H can correspond to a numerical value of 3.

In some implementations, values in the set of values are determined for a single survey based on multiple calculations. Example calculations include, without limitation, an aggregate calculation for the overall value, and a calculation for each of the dimensions. In some examples, the overall value is determined as the sum of answer values across all answers selected by the user in completing the survey. Using the example of Table 1, answers in the first answer column can be associated with an answer value of 1, answers in the second answer column can be associated with an answer value of 2, and answers in the third answer column can be associated with an answer value of 3. Consequently, and for a survey using the first change management tool having 22 questions, the range of overall values includes 22-66. In some examples, each dimension value is determined as the sum of answer values across all answers that correspond to a respective dimension. Consequently, a respective range of dimension values can be provided for each dimension. Using the example above, questions 1-5 can correspond to scope, questions 6-9 can correspond to complexity, questions 10-13 can correspond to degree of change, questions 14-17 can correspond to support, and questions 18-22 can correspond to change readiness. Accordingly, the range of dimension values for scope is 5-15, the range of dimension values for complexity is 4-12, the range of dimension values for degree of change is 4-12, the range of dimension values for support is 4-12, and the range of dimension values for change readiness is 5-15.

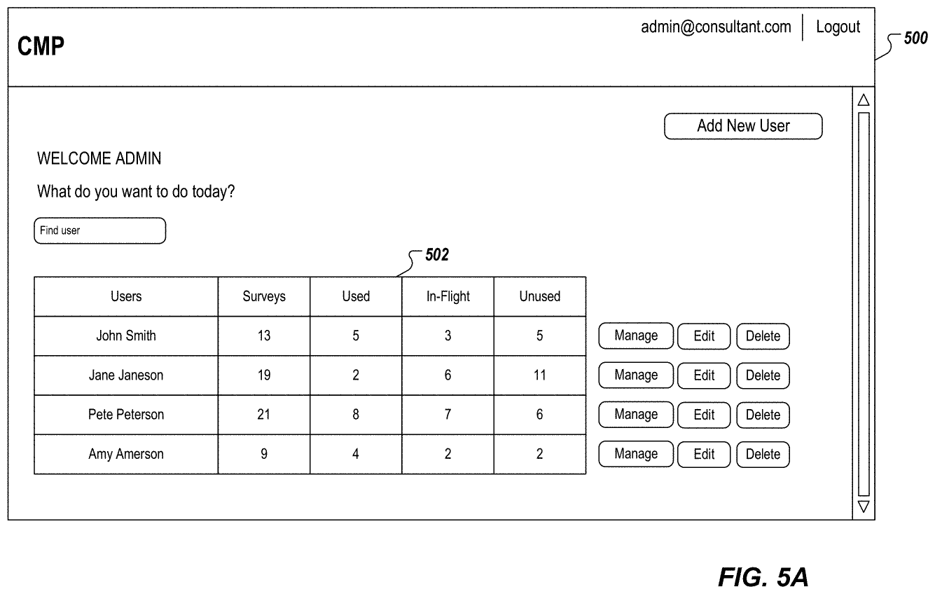

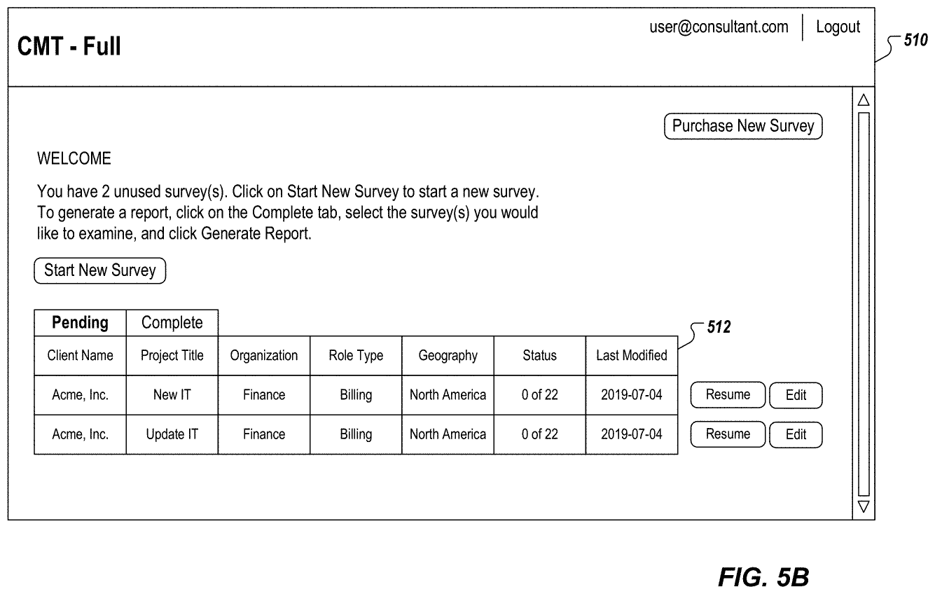

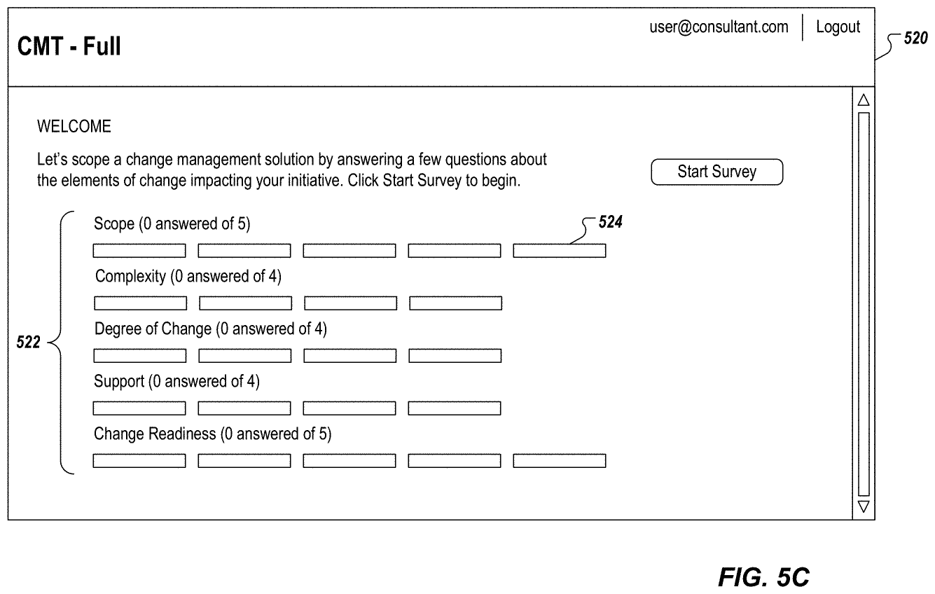

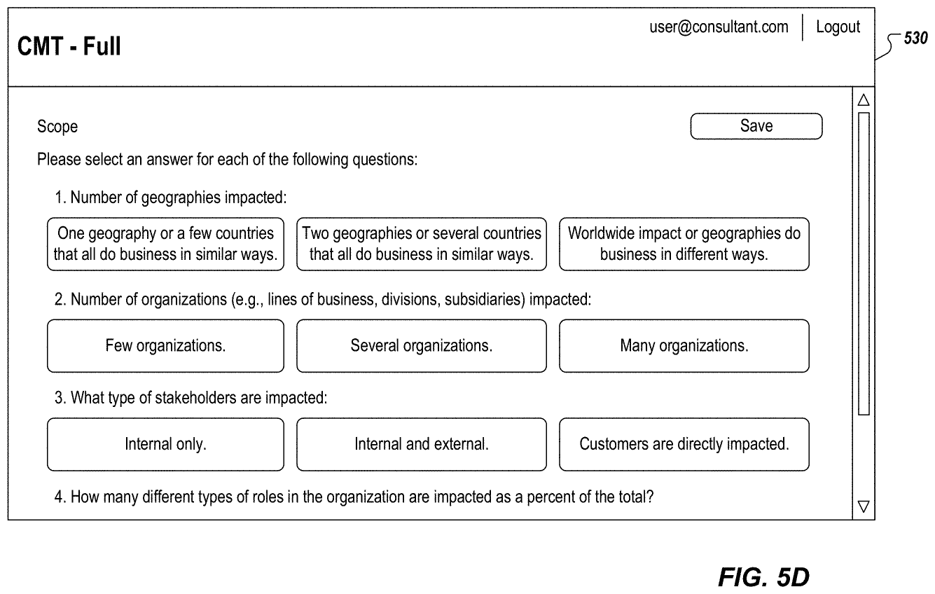

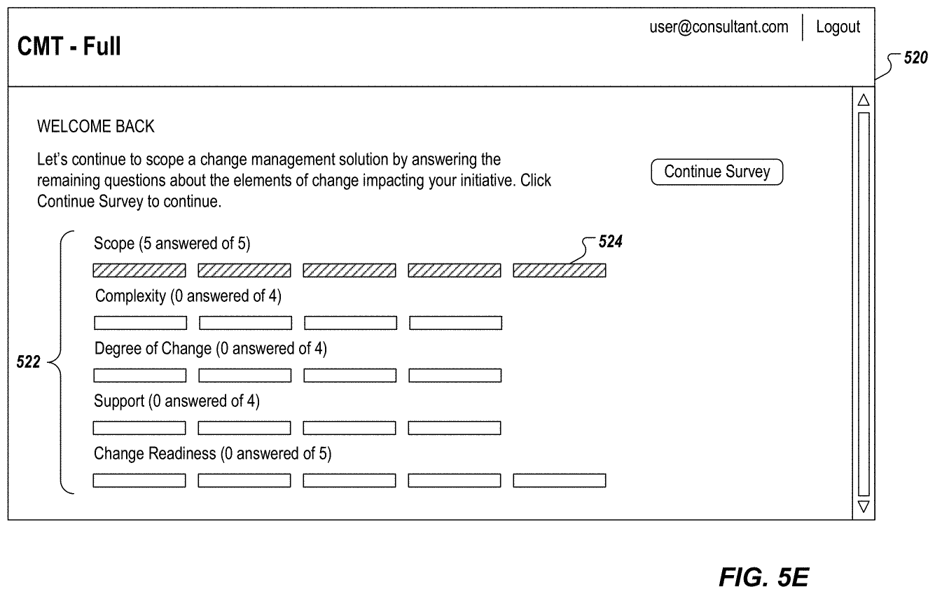

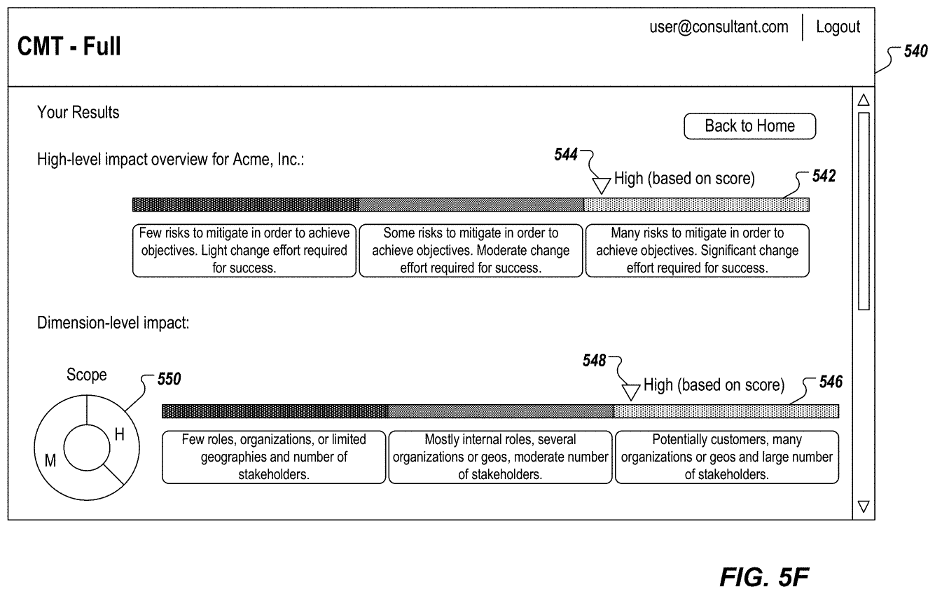

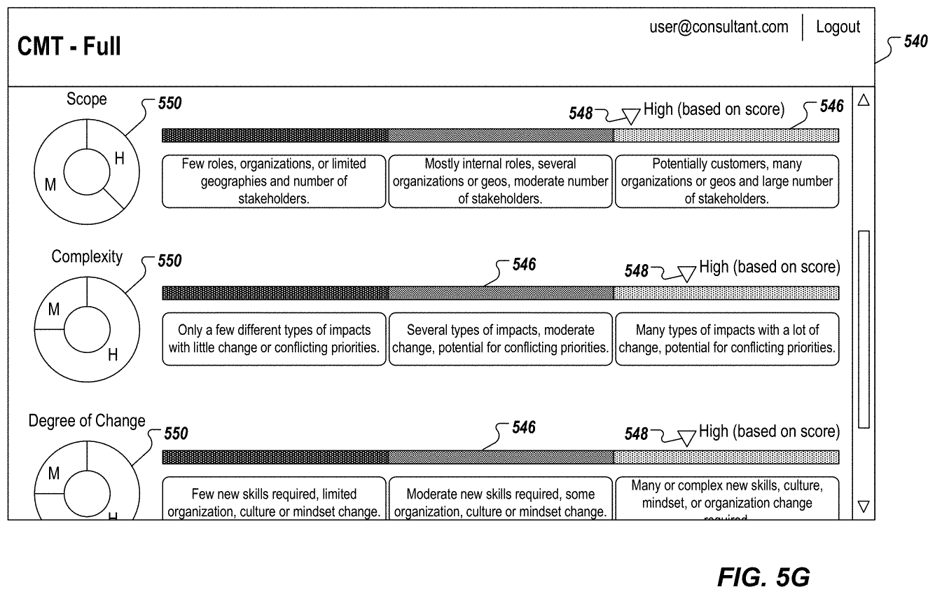

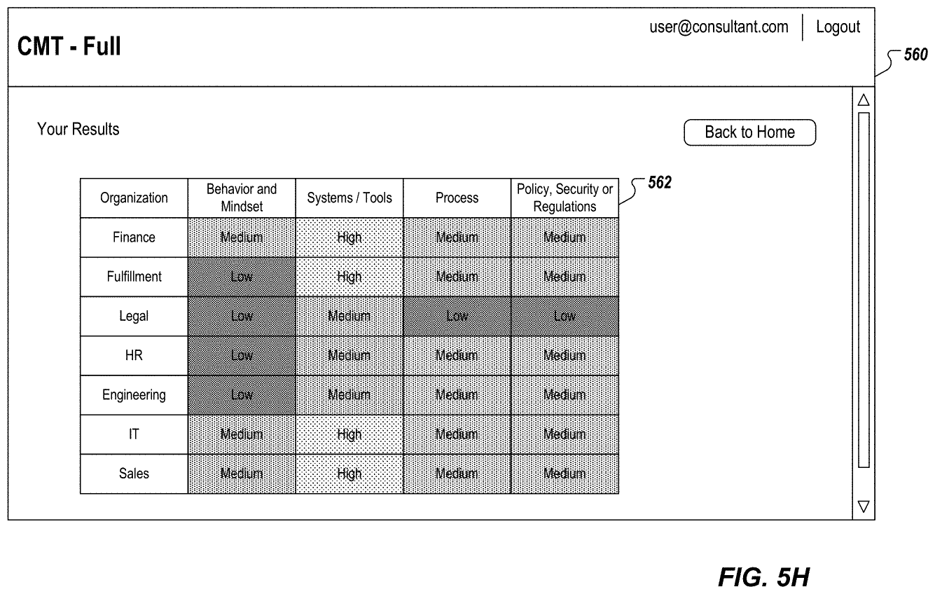

In some implementations, a first report is provided and includes graphical representations. In some examples, graphical representations include graphical representations based on values in the set of values. For example, an overall bar graph can be provided, which graphically depicts the range of overall values and the overall value calculated for a respective survey. As another example, a dimension bar graph can be provided, which graphically depicts the range of dimension values and the dimension value calculated for a respective dimension for a respective survey. In some examples, graphical representations include pie charts depicting a relative count of answers based on respective answer values. For example, answer values can include L (e.g., associated with 1), M (e.g., associated with 2), H (e.g., associated with 3). An overall pie chart can be provided, which depicts the number of each answer value relative to all answers selected in a respective survey. A dimension pie chart can be provided, which depicts the number of each answer value relative to all answers selected for a respective dimension in a respective survey. Examples graphical representations are described in further detail herein with reference to FIGS. 5A-5H.

In some implementations, a second report is provided and includes a heatmap. An example heatmap in the context of the present disclosure includes a heatmap by impact type and organization (e.g., within the enterprise). Example organizations include, without limitation, finance, fulfillment, legal, human resources (HR), engineering, IT, and sales. Example impact types include, without limitation, behavior and mindset, systems/tools, process, and policy, security and regulations. In some examples, organization correlates to the organization name selected when taking the survey, as described in further detail herein. Data is aggregated for organizations selected with the same name within the same “project” or data set. Accordingly, there can be one or more surveys per organization. In providing the heatmap, example calculations are described below are for a single survey. If multiple surveys per organization are provided, the calculations across all surveys can be aggregated for representation within the heatmap.

In some implementations, each impact type is associated with a sub-set of questions in the survey, the sub-set of questions including one or more questions. Continuing with the example of Table 1, above, behavior and mindset can be associated with questions 11-13, systems/tools can be associated with question 8, process can be associated with question 9, and policy, security and regulations can be associated with question 6. Using these examples, for each impact type and organization, and AGGREGATE and AVERAGE of associated questions can be determined. A response in the “L” column=1, “M”=2, and “H”=3 points. Consequently, for behavior and mindset, the range of possible points per survey is 3-9 (e.g., L is 3-4, M is 5-7, High is 8-9), and for the other example impact types, the range of possible points per survey is 1-3 (e.g., L is 1, M is 2, H is 3). Within the heatmap, a visual indicator can be provided based on the respective points. Example visual indicators can include, without limitation, color and fill. An example heatmap is described in further detail herein with reference to FIGS. 5A-5H.

In some implementations, a set of actions can be determined based on the answer provided to the survey. In some examples, the set of actions can be provided in sub-sets. Example sub-sets include, without limitation, change activities, and process activities. In some examples, each action can be designated as a required action or an optional action. In some examples, a team responsible and/or a team accountable for each recommended action can be indicated. In some examples, a time estimate for performing each recommended action can be provided.

In further detail, a mapping can be provided that defines correlations between one or more answers and one or more actions, and to one or more overall values and one or more actions. In some examples, the mapping is provided as a computer-readable file that associates an action to one or more answers or associates an action to one or more overall values. In some examples, for each action, the mapping identifies whether the action is required or optional, an entity that is responsible for the action, an entity that is accountable for the action, and a time estimate for the action (e.g., an estimated number of days to perform the action). In some implementations, for each answer selected, the mapping is cross-referenced to identify one or more actions corresponding to the particular action, and the one or more actions can be included in a set of actions for the particular survey. In some implementations, one or more actions can correspond to an overall value determined based on all answers selected in the survey. In some examples, upon completion of the survey, the overall score is determined, and one or more actions are identified based on the overall score, the one or more actions also being included in the set of actions. The set of actions can be displayed as a third report (e.g., a table of actions for the respective survey).

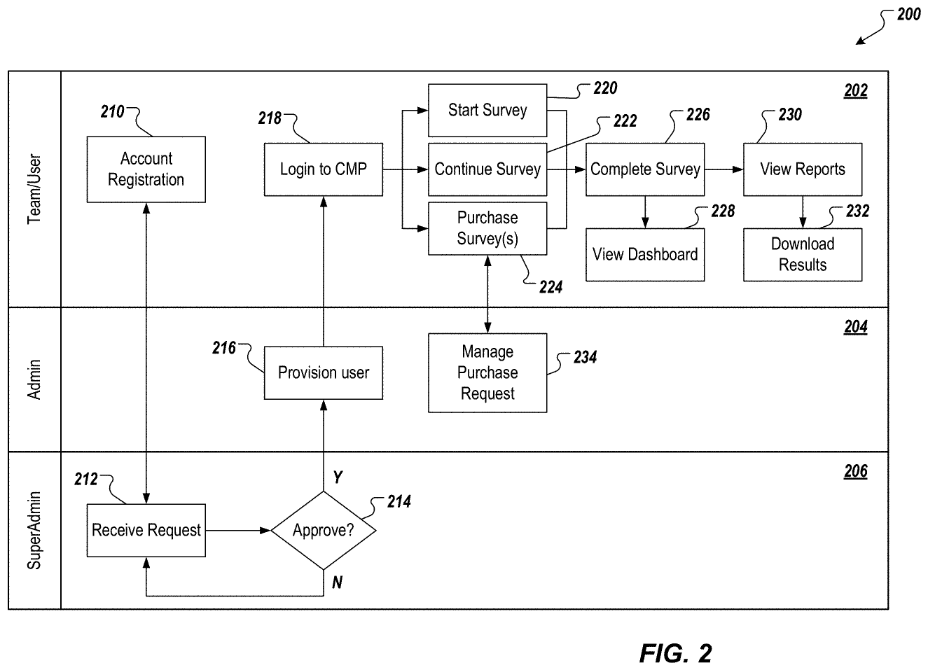

FIG. 2 depicts an example process flow 200 in accordance with implementations of the present disclosure. The example process flow 200 includes activities that can be executed based on roles, example roles including a team/user role 202, an administrator role 204, and a super administrator (superadmin) role 206. In some examples, the roles are provided in a multi-level hierarchy and a console view is provided for each role (e.g., superadmin console, admin console, team console). In some examples, activities performed by the respective roles are performed using the respective consoles (i.e., UIs).

In the example of FIG. 2, the example process flow 200 includes account registration (210), which can be performed by a user (e.g., a team member). In some examples, the user submits a request to register an account with the change management platform (e.g., through a UI), if the user does not already have an account. In some examples, a superadmin user receives the request (212) and determines whether to approve the request (214). In some examples, if the superadmin user approves the request, an administrator user provisions the user (216) within the change management platform. For example, the administrator user establishes an account for the user within the change management platform including credentials (e.g., username, password).

Once the user has an account established in the change management platform, the user can log into the change management platform (218). In some examples, the user can select a particular CMT to use within the change management platform. For example, a graphical representation of the first CMT (e.g., CMT-Full) and a graphical representation of the second CMT (e.g., CMT-Agile) can be displayed in a UI, and the user can select a CMT by clicking on a respective graphical representation. Within a CMT, the user can, among other possible actions, select to either start a survey (220), continue a survey (222), and purchase one or more additional surveys 224. In some examples, if the user selects to start a survey, a new survey is displayed to the user within one or more UIs and the user can interact with the survey to eventually complete the survey (226), as described in further detail herein. In some examples, if the user selects to continue a survey, the selected survey is retrieved from memory and is displayed to the user within one or more UIs, and the user can interact with the survey to eventually complete the survey (226), as described in further detail herein.

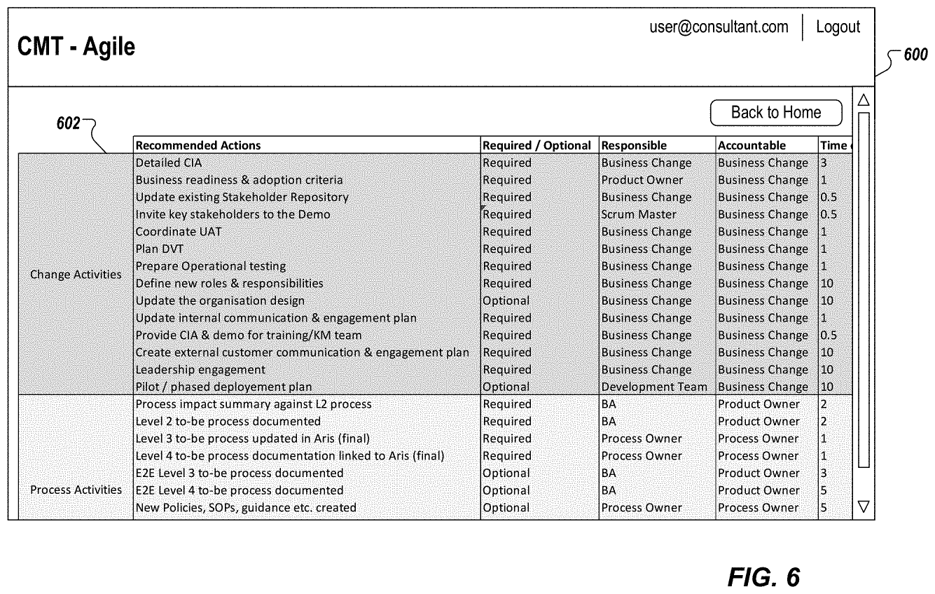

In accordance with implementations of the present disclosure, after the survey is complete, the user can view results in one or more dashboards (228), can view reports (230), and/or can download results (232). Examples of dashboards and reports are described in further detail herein and are depicted in FIGS. 5A-5H and 6. In some examples, downloading of results can include, without limitation, downloading one or more data files representing the results and/or reports (e.g., image files, spreadsheet files).

In some implementations, if the user selects to purchase one or more surveys, the administrator user manages the purchase request (234). In some examples, managing the purchase request can include, among other activities, approving the purchase request and provisioning the user's account with the requested number of surveys.

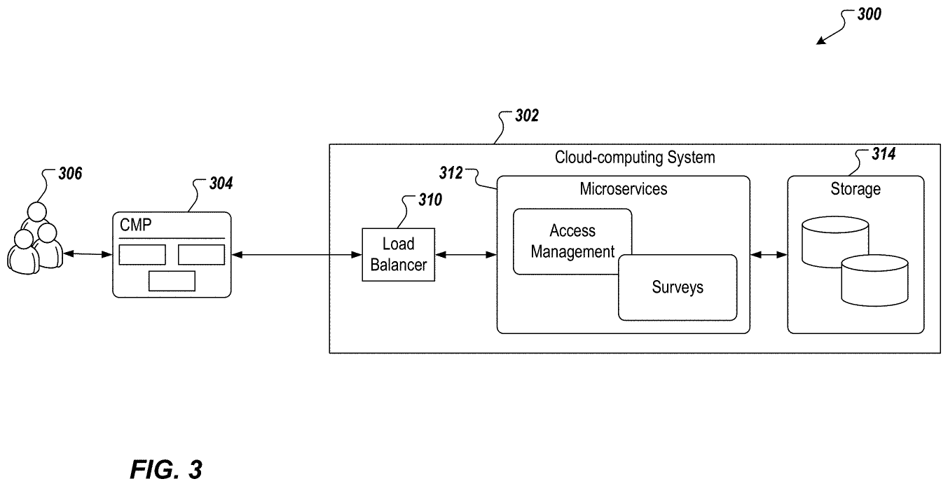

FIG. 3 depicts an example conceptual architecture 300 in accordance with implementations of the present disclosure. The example conceptual architecture 300 includes a cloud-computing system 302 and a front-end 304. In some examples, the cloud-computing system 302 hosts the change management platform including the suite of change management tools. An example cloud-computing platform 302 includes, but is not limited to, Amazon Web Services (AWS) provided by Amazon. In some examples, one or more users 306 interact with the change management platform through the front-end 304. For example, the front-end 304 displays UIs, examples of which are described in further detail herein with reference to FIGS. 5A-5H, through which the users 306 are able to interact with the change management platform.

In the example of FIG. 3, the cloud-computing system 302 includes a load balancer 310, a set of microservices 312, and storage 314. In some implementations, the change management platform, and each of the change management tools, are provided as one or more microservices 312 hosted within the cloud-computing system 302. Accordingly, the change management platform can be provided in a so-called service-oriented architecture (SOA), in which respective micro-services perform one or more functions (e.g., access management, surveys). In some examples, each of the microservices is accessed through one or more APIs, as described in further detail herein.

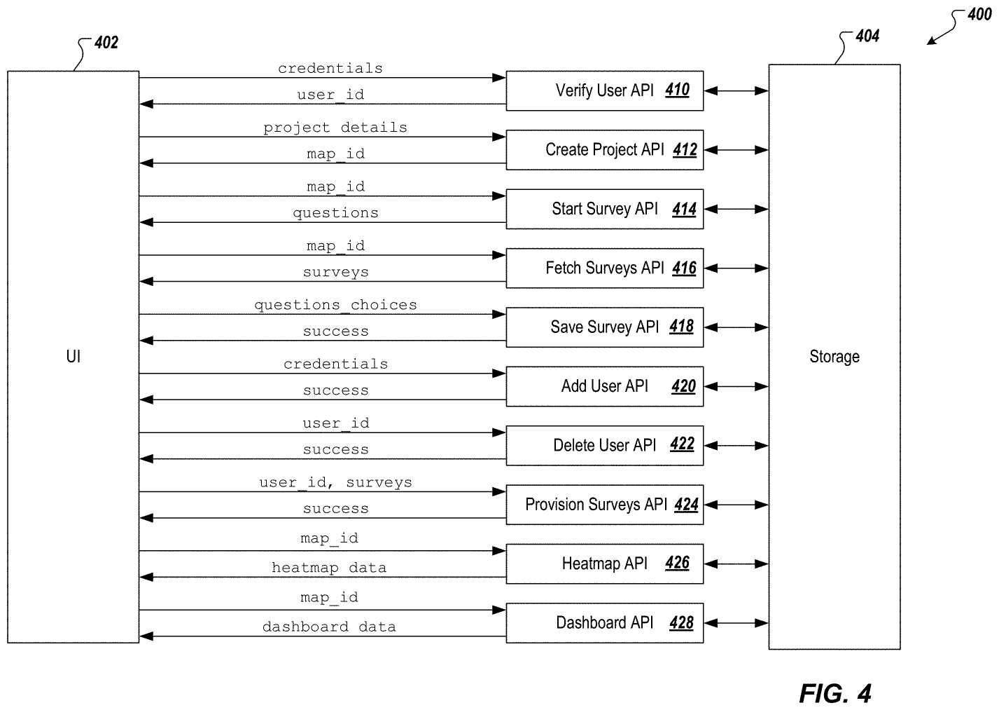

FIG. 4 depicts an example workflow sequence diagram 400 in accordance with implementations of the present disclosure. The example workflow sequence diagram 400 includes interactions between one or more UIs 402 and storage 404 (e.g., the storage 314 of FIG. 3) through APIs (e.g., APIs of the microservices 312 of FIG. 3). In the example of FIG. 4, depicted APIs include a verify user API 410, a create project API 412, a start survey API 414, a fetch survey API 416, a save survey API 418, an add user API 420, a delete user API 422, a provision surveys API 424, a heatmap API, 426, and a dashboard API 428. Although example APIs corresponding to respective microservices are depicted in FIG. 4, it is contemplated that implementations of the present disclosure can be realized using any appropriate API.

In some examples, a user logs into the change management platform by providing credentials (e.g., through a UI), and the credentials are transmitted to authenticate (verify) the user through the verify user API 410. In some examples, the verify user API 410 compares the received credentials to credentials stored for the user in the storage 404. In some examples, if the user is authenticated, the user is able to interact with the change management platform to the extent of the user's permission based on a role assigned to the user (e.g., user, administrator, superadmin).

In some examples, the user can create a change management project that is to be evaluated using the change management platform. For example, the user submits project details through the create project API 412, which establishes a project within the change management platform (e.g., stores the project within the storage 404). Example project details can include, without limitation, project name, and organization (e.g., finance, fulfillment, legal, human resources (HR), engineering, IT, sales). In some examples, the user can start a survey (e.g., for a respective project) by submitting a start survey request through the start survey API 414. In some examples, in response to the start survey request, the start survey API retrieves a respective survey from storage 404 for presentation to the user. In some examples, the survey is based on the respective CMT that the user is interacting with (e.g., CMT-Full, CMT-Agile). In some examples, the user can continue a survey (e.g., for a respective project) by submitting a continue survey request through the fetch surveys API 416. In some examples, in response to the continue survey request, the fetch surveys API retrieves a respective survey from storage 404 for presentation to the user including the last-saved state of the survey (e.g., partial completion). In some examples, the user can save a survey (e.g., a completed survey, a partially completed survey) by submitting a save survey request through the save survey API 418, which stores the survey, in its current state, to the storage 404.

In some implementations, the add user API 420, the delete user API 422, and the provision surveys API 424 are used by a user having permissions to manage users and surveys within the change management platform (e.g., administrator, superadmin). For example, the user can add a user to the change management platform by providing credentials for the user through the add user API 420, which stores the user and credentials in the storage 404. As another example, the user can delete a user from the change management platform by providing a user identifier of the user that is to be deleted through the delete user API 422, which marks the user as deleted in the storage 404 and/or deletes the user and respective credentials from the storage 404. In some examples, the user provisions one or more surveys requested by a user by submitting a survey provision request through the provision surveys API.

In some implementations, one or more reports and/or graphical representations of survey results are provided based on requests submitted through one or more APIs. In the non-limiting example of FIG. 4, the heatmap API 426 returns heatmap data for display of a heatmap to the user (e.g., within a UI), and the dashboard API 428 returns dashboard data for display of a dashboard to the user (e.g., within a UI), as described in further detail herein.

FIGS. 5A-5H depict example user interfaces (UIs) in accordance with implementations of the present disclosure.

With particular reference to FIG. 5A, a UI 500 is depicted and can be displayed to an administrator (e.g., as a web page displayed within a browser). For example, the administrator can log into the change management platform (CMP) through a log-in UI (not depicted) and, in response to the administrator being authenticated, the UI 500 can be displayed. In some examples, the administrator can interact with the UI 500 to perform tasks (e.g., manage users, edits users, add users, delete users). In the depicted example, the UI 500 depicts a table 502 that summarizes users and survey state per user.

With particular reference to FIG. 5B, a UI 510 is depicted and can be displayed to a user (e.g., as a web page displayed within a browser). For example, the user can log into the change management platform (CMP) through a log-in UI (not depicted) and, in response to the administrator being authenticated, the user can be provided access to the change management platform. In some examples, a UI can be displayed that enable the user to select one of a plurality of tools provided by the change management platform. As described herein, example tools include CMT-Full and CMT-Agile. In some examples, the UI 510 is displayed in response to user selection of CMT-Full. In some examples, the user can interact with the UI 510 to perform tasks (e.g., start a survey, resume a survey, purchase a new survey). In the depicted example, the UI 510 depicts a table 512 that summarizes surveys that the user has access to within the change management platform (e.g., pending surveys, complete surveys).

With particular reference to FIG. 5C, a UI 520 is depicted and can be displayed to a user (e.g., as a web page displayed within a browser). For example, the UI 520 can be displayed in response to the user selecting a survey that is to be completed. In the example of FIG. 5C, the UI 520 includes a progress graphic 522 that depicts progress through the survey. More particularly, the progress graphic 522 identifies each dimension (e.g., scope, complexity, degree of change, support, change readiness) and provides a graphic 524 (e.g., rectangle) representative of a question. In some examples, a visual characteristic of each graphic 524 changes in response to completion of the underlying question.

With particular reference to FIG. 5D, a UI 530 is depicted and can be displayed to a user (e.g., as a web page displayed within a browser). For example, the UI 530 can be displayed in response to the user selecting a survey for execution. In the example of FIG. 5D, each question within the survey is depicted along with respective answers for the questions. In some examples, each answer is represented as a user-selectable UI element (e.g., button) that the user can click on to select an answer. In some examples, the user can progress through all questions of the survey, or can save the survey before completion and return to the survey later for completion. In some implementations, the UI 530 can display questions on a question-by-question basis (e.g., the user answers a question and the next question is displayed). In some implementations, and as depicted in FIG. 5D, the UI 530 can display a set of questions, the set of questions corresponding to a particular dimension. In some examples, after the user has answered the set of questions for the dimension, a next set of questions is displayed for another dimension.

With particular reference to FIG. 5E, the UI 520 is depicted and can again be displayed to the user (e.g., as a web page displayed within a browser). For example, the UI 520 can again be displayed in response to the user completing at least a portion of the survey. In the example of FIG. 5E, the user has completed the questions for the scope dimension. Consequently, the visual characteristic of each graphic 524 under the dimension is changed.

FIGS. 5F and 5G depict a UI 540 that displays a first report that is based on a completed survey. As described above, the first report includes graphical representations include graphical representations based on values in the set of values. For example, an overall bar graph 542 can be provided, which graphically depicts the range of overall values and an overall value 544 calculated for a respective survey. As another example, a dimension bar graph 546 can be provided, which graphically depicts the range of dimension values and the dimension value 548 calculated for a respective dimension for a respective survey. In some examples, graphical representations include pie charts 550 depicting a relative count of answers based on respective answer values. For example, each pie chart depicts a number of answers having an answer value of L (e.g., associated with 1), a number of answers having an answer value of M (e.g., associated with 2), and a number of answers having an answer value of H (e.g., associated with 3), relative to one another.

FIG. 5H depicts a UI 560 that displays a second report that is based on one or more completed surveys. As described above, the second report includes a heatmap 562 that is generated based on answer values of questions associated with impact types as described herein.

FIG. 6 depicts a UI 600 depicting a table of actions 602. In some examples, the table of actions graphically depicts a set of actions determined based on the answers and the overall score using a mapping that is specific to the particular survey and/or CMT (e.g., CMT-Agile). For example, the overall score is used to cross-reference the mapping and identify one or more actions included in the set of actions. In the depicted example, the action “Detailed CIA” is selected in response to the overall score being a first value (e.g., “XL” or “L”). If the overall score had been a second value (e.g., “M”), the action “Light-Touch CIA” would have been selected for inclusion in the set of actions. As another example, each answer can be used to cross-reference the mapping and identify one or more actions to be included in the set of actions. In the depicted example, the action “Define new roles & responsibilities” is selected in response to the answer to question 2 of Table 2 being “New roles and responsibilities are required and not yet defined.” If the answer to question 2 had been “New roles and responsibilities are required and defined,” “Review the existing roles & responsibilities” would have been selected for inclusion in the set of actions based on the mapping. If the answer to question 2 had been “No changes in roles & responsibilities,” no action associated with question 2 would have been selected for inclusion in the set of actions.

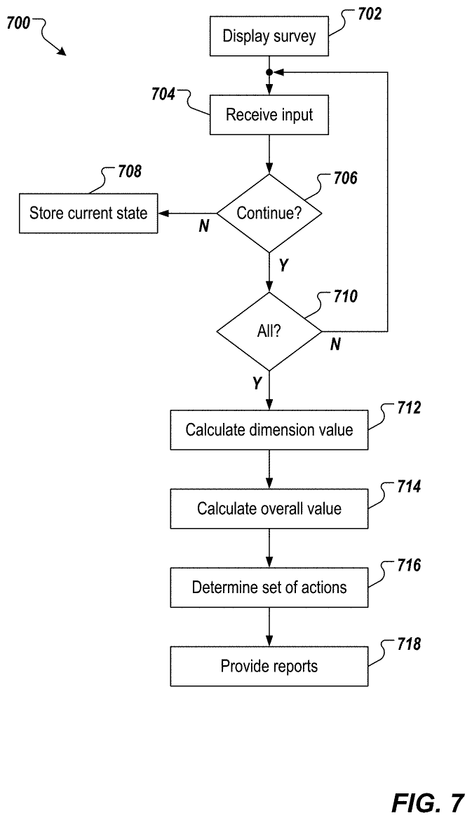

FIG. 7 depicts an example process 700 that can be executed in accordance with implementations of the present disclosure. In some examples, the example process 700 is provided using one or more computer-executable programs executed by one or more computing devices. For example, the example process 700 is provided using one or more microservices hosted within a cloud-computing system (e.g., the microservices 312 hosted in the cloud-computing environment 302 of FIG. 3).

A survey is displayed (702). For example, and as described herein, a UI is displayed that depicts one or more questions and, for each question, a set of answers. Input is received (704). For example, the user provides input to the UI indicating a user selection. In some examples, the input can indicate user selection of a save option to save the current state of the survey (e.g., and exit the survey to continue later). In some examples, the input can indicate user selection of an answer from the set of answers for a respective question. It is determined whether to continue (706). For example, if the input indicates user selection of a save option to save the current state of the survey, the current state of the survey is stored (708). As another example, if the input indicates user selection of an answer from the set of answers for a respective question, it is determined whether all questions of the survey have been answered (710). If not all questions have been answered, the example process 700 loops back.

If all questions have been answered, dimension values are calculated (712). For example, and as described herein, for each dimension, answer values for the answers selected for the questions associated with the dimension are aggregated to provide the dimension value. An overall value is calculated (714). For example, and as described herein, the overall value is determined as the sum of answer values across all answers selected by the user in completing the survey. A set of actions is determined (716). For example, and as described herein, a mapping defines correlations between one or more answers and one or more actions, and to one or more overall values and one or more actions. In some examples, for each answer selected, the mapping is cross-referenced to identify one or more actions corresponding to the particular action, and the one or more actions can be included in a set of actions for the particular survey. In some examples, for the overall score, the mapping is cross-referenced to identify one or more actions associated with the overall score, and the one or more actions are included in the set of actions.

One or more reports are provided (718). For example, and as described herein, one or more of a first report, a second report, and a third report are provided for display to the user. In some examples, the first report includes graphical representations. In some examples, graphical representations include graphical representations based on values in the set of values. For example, an overall bar graph can be provided, which graphically depicts the range of overall values and the overall value calculated for a respective survey. As another example, a dimension bar graph can be provided, which graphically depicts the range of dimension values and the dimension value calculated for a respective dimension for a respective survey. In some examples, graphical representations include pie charts depicting a relative count of answers based on respective answer values. An example of the first report is depicted in FIGS. 5F and 5G. In some examples, the second report includes a heatmap that correlates organizations to impact types. An example of the second report is depicted in FIG. 5H. In some examples, the third report includes a table of actions that summarizes actions in the set of actions determined for the respective survey. An example of the third report is depicted in FIG. 6.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code) that constitutes processor firmware, a protocol stack, a database management system, an operating system, or a combination of one or more of them. A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display), LED (light-emitting diode) monitor, for displaying information to the user and a keyboard and a pointing device (e.g., a mouse or a trackball), by which the user may provide input to the computer. Other kinds of devices may be used to provide for interaction with a user as well; for example, feedback provided to the user may be any appropriate form of sensory feedback (e.g., visual feedback, auditory feedback, or tactile feedback); and input from the user may be received in any appropriate form, including acoustic, speech, or tactile input.

Implementations may be realized in a computing system that includes a back end component (e.g., as a data server), or that includes a middleware component (e.g., an application server), or that includes a front end component (e.g., a client computer having a graphical user interface or a Web browser through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”) (e.g., the Internet).

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the to be filed claims.

What is claimed is:

1. A computer-implemented method for providing a change management platform to evaluate change in an enterprise, the method being executed by one or more processors and comprising:
receiving first user input from a user, the first input indicating selection of a first change management tool from a set of change management tools provided by the change management platform;
providing a first survey for display to the user, the first survey including one or more questions, the first survey being specific to the first change management tool selected by the user;
receiving a first set of user answers comprising user input indicating user selection of a set of answers to the first survey;
calculating an overall value and a set of dimension values based on answer values assigned to answers in the set of answers selected by the user; and
providing one or more reports for display to the user, each of the one or more reports comprising graphical representations based on the overall value and the set of dimension values.

2. The method of claim 1, further comprising determining a set of actions based on one or more of the overall value and one or more answers in the set of answers.

3. The method of claim 2, wherein determining a set of actions is executed using a mapping that associates one or more overall values to at least one action and that associates at least one answer of the one or more answers to at least one action.

4. The method of claim 2, wherein at least two actions are included in the set of actions based on the overall value.

5. The method of claim 2, wherein a respective action is included in the set of actions based on each of the one or more answers.

6. The method of claim 1, wherein a type of each of the overall value and the dimension values is specific to the first change management tool selected by the user.

7. The method of claim 1, further comprising:
receiving second user input from the user, the second input indicating selection of a second change management tool from the set of change management tools;
providing a second survey for display to the user, the second survey being specific to the second change management tool selected by the user;
receiving a second set of user answers comprising user input indicating user selection of a set of answers to the second survey;
calculating an overall value and a set of dimension values based on answer values assigned to answers in the set of answers selected by the user; and
providing one or more reports for display to the user, each of the one or more reports comprising graphical representations based on the overall value and the set of dimension values.

8. The method of claim 1, further comprising retrieving the first survey from a plurality of pre-defined surveys based on the first change management tool selected by the user.

9. The method of claim 8, further comprising:
receiving configuration data from an administrator; and
updating one or more surveys of the plurality of pre-defined surveys based on the configuration data.

10. A non-transitory computer-readable storage medium coupled to one or more processors and having instructions stored thereon which, when executed by the one or more processors, cause the one or more processors to perform operations for providing a change management platform to evaluate change in an enterprise, the operations comprising:
receiving first user input from a user, the first input indicating selection of a first change management tool from a set of change management tools provided by the change management platform;
providing a first survey for display to the user, the first survey including one or more questions, the first survey being specific to the first change management tool selected by the user;
receiving a first set of user answers comprising user input indicating user selection of a set of answers to the first survey;
calculating an overall value and a set of dimension values based on answer values assigned to answers in the set of answers selected by the user; and
providing one or more reports for display to the user, each of the one or more reports comprising graphical representations based on the overall value and the set of dimension values.

11. The computer-readable storage medium of claim 10, wherein operations further comprise determining a set of actions based on one or more of the overall value and one or more answers in the set of answers.

12. The computer-readable storage medium of claim 11, wherein determining a set of actions is executed using a mapping that associates one or more overall values to at least one action and that associates at least one answer of the one or more answers to at least one action.

13. The computer-readable storage medium of claim 11, wherein at least two actions are included in the set of actions based on the overall value.

14. The computer-readable storage medium of claim 11, wherein a respective action is included in the set of actions based on each of the one or more answers.

15. The computer-readable storage medium of claim 10, wherein a type of each of the overall value and the dimension values is specific to the first change management tool selected by the user.

16. The computer-readable storage medium of claim 10, wherein operations further comprise:
receiving second user input from the user, the second input indicating selection of a second change management tool from the set of change management tools;
providing a second survey for display to the user, the second survey being specific to the second change management tool selected by the user;
receiving a second set of user answers comprising user input indicating user selection of a set of answers to the second survey;
calculating an overall value and a set of dimension values based on answer values assigned to answers in the set of answers selected by the user; and
providing one or more reports for display to the user, each of the one or more reports comprising graphical representations based on the overall value and the set of dimension values.

17. The computer-readable storage medium of claim 10, wherein operations further comprise retrieving the first survey from a plurality of pre-defined surveys based on the first change management tool selected by the user.

18. The computer-readable storage medium of claim 17, wherein operations further comprise:
receiving configuration data from an administrator; and
updating one or more surveys of the plurality of pre-defined surveys based on the configuration data.

19. A system, comprising:
a computing device; and
a computer-readable storage device coupled to the computing device and having instructions stored thereon which, when executed by the computing device, cause the computing device to perform operations for natural language explanations for providing a change management platform to evaluate change in an enterprise, the operations comprising:
receiving first user input from a user, the first input indicating selection of a first change management tool from a set of change management tools provided by the change management platform;
providing a first survey for display to the user, the first survey including one or more questions, the first survey being specific to the first change management tool selected by the user;
receiving a first set of user answers comprising user input indicating user selection of a set of answers to the first survey;
calculating an overall value and a set of dimension values based on answer values assigned to answers in the set of answers selected by the user; and
providing one or more reports for display to the user, each of the one or more reports comprising graphical representations based on the overall value and the set of dimension values.

20. The system of claim 19, wherein operations further comprise determining a set of actions based on one or more of the overall value and one or more answers in the set of answers.

21. The system of claim 20, wherein determining a set of actions is executed using a mapping that associates one or more overall values to at least one action and that associates at least one answer of the one or more answers to at least one action.

22. The system of claim 20, wherein at least two actions are included in the set of actions based on the overall value.

23. The system of claim 20, wherein a respective action is included in the set of actions based on each of the one or more answers.

24. The system of claim 19, wherein a type of each of the overall value and the dimension values is specific to the first change management tool selected by the user.

25. The system of claim 19, wherein operations further comprise:
receiving second user input from the user, the second input indicating selection of a second change management tool from the set of change management tools;
providing a second survey for display to the user, the second survey being specific to the second change management tool selected by the user;
receiving a second set of user answers comprising user input indicating user selection of a set of answers to the second survey;
calculating an overall value and a set of dimension values based on answer values assigned to answers in the set of answers selected by the user; and
providing one or more reports for display to the user, each of the one or more reports comprising graphical representations based on the overall value and the set of dimension values.

26. The system of claim 19, wherein operations further comprise retrieving the first survey from a plurality of pre-defined surveys based on the first change management tool selected by the user.

27. The system of claim 26, wherein operations further comprise:
receiving configuration data from an administrator; and
updating one or more surveys of the plurality of pre-defined surveys based on the configuration data.
